(19) United States
(12) Patent Application Publication
(10) Pub. No.: US 2005/0011305 A1
(43) Pub. Date: Jan. 20, 2005

(54) Quick entry clipless bicycle pedal

(76) Inventor: Jesse Menayan, Daly City, CA (US)

Correspondence Address: CISLO & THOMAS, LLP, 233 WILSHIRE BLVD, SUITE 900, SANTA MONICA, CA, 90401-1211, US

(21) Appl. No.: 10/632,595

(22) Filed: Aug. 1, 2003

Related U.S. Application Data
(60) Provisional application No. 60/415,570, filed on Oct. 3, 2002.

(51) Int. Cl. G05G 1/14

(52) U.S. Cl. 74/594.6

(57) ABSTRACT

Disclosed is a clipless bicycle pedal system for safely securing the rider's shoe to the pedal by providing an easily targeted pedal platform, wherein engagement and disengagement of the rider's cleated shoe is co-axial with the pedal, resulting in a true “no look” engagement method. Additionally, the pedal provides for float incorporating axial side-to-side motion, as well as twist motion. This combined twist and axial float provides a wide range of free motion that further reduces the chance of injury and better simulates total freedom of leg/ foot joint action by not limiting joint movements to an axially fixed connection of the pedal to the rider's shoe.

### CROSS-REFERENCES TO RELATED APPLICATIONS

This application claims priority from U.S. Provisional Application Ser. No. 60/415,570 filed Oct. 24, 2002, which is incorporated herein by this reference.

### BACKGROUND OF THE INVENTION

1. Field of the Invention

This invention relates generally to bicycle equipment, and more specifically to cleat systems for bicycle pedals.

2. Description of the Related Art

The past and current state of technology in the competitive cycling field has focused on the development and use of clipless bicycle pedal systems which allow for a complete securing of the shoe to the cranks and fast entry of the shoe onto the pedal. These systems typically comprise a pedal that attaches to the crank arm of the bicycle, in a manner similar to traditional bicycle pedals, and a cleat that attaches to the shoe of the rider and engages the pedal.

Additionally, since there are variations in the manner in which different riders move their legs, prior art systems have provided for a twisting movement of the foot on the pedal referred to as “float.” This freedom of movement allows a rider to laterally twist his/her heel, thus allowing for movement of the ankles and knees, and reducing the chances of injuries to the leg/foot joints. Such twist float still limits the range of motion of the foot to twisting about a fixed point at which the shoe is attached to the pedal, however. Furthermore, it is typically advantageous to minimize the time required for the shoe to engage to the pedal, while simultaneously reducing the need for the rider to look down at the pedal to properly locate the shoe for engagement into the pedal. Typical systems which provide for single, double, and even four sided pedal platform though still require the rider to look in order to engage the shoe to the platform, which may result in a safety hazard.

### SUMMARY OF THE INVENTION

The present invention provides a unique clipless bicycle pedal system for safely securing the rider's shoe to the pedal by providing an easily targeted pedal platform, wherein engagement and disengagement of the rider's cleated shoe is co-axial with the pedal, resulting in a true “no look” engagement method. Additionally, the pedal provides for float incorporating axial side-to-side motion, as well as twist motion. This combined twist and side-to-side axial float provides a wide range of free motion that further reduces the chance of injury and better simulates total freedom of leg/foot joint action by not limiting joint movements to an axially fixed connection of the pedal to the rider's shoe.

According to a preferred embodiment, the pedal comprises an infinite-sided pedal platform that allows the shoe of the rider to engage onto the pedal over a full 360 degrees of the face of the pedal platform.

In normal operation, the rider places his/her cleated shoe onto the pedal platform and presses his/her foot down, at which point the cleat locates itself onto the pedal and a spring-loaded latch secures the shoe to the pedal. To disengage, the rider twists his/her foot to a predetermined amount, the latch is released, and the shoe/foot disengages from the pedal.

### OBJECTS OF THE INVENTION

It is an object of the present invention to provide a clipless bicycle pedal system having easily targeted pedal platform, wherein engagement and disengagement of the rider's cleated shoe is co-axial with the pedal.

It is a further object of the present invention to provide a clipless bicycle pedal system, which engages a rider's shoe, and provides for float utilizing side-to-side axial motion.

It is a further object of the present invention to provide a clipless bicycle pedal system which engages a rider's shoe, and provides for float utilizing side-to-side axial motion as well as lateral twist motion.

It is a further object of the present invention to provide a clipless bicycle pedal system utilizing a true, “no look” engagement mechanism.

It is a further object of the present invention to provide an infinite-sided pedal platform, which allows the shoe of a rider to engage onto the pedal over a full 360 degrees of the face of the pedal platform.

Other objects and advantages of the present invention will be apparent from a review of the following specification and accompanying drawings.

### BRIEF DESCRIPTION OF THE DRAWINGS

FIG. 1 is a conceptual side view of a bicycle pedal and cleat of the system of the present invention in accordance with a preferred embodiment.

FIG. 2 is a perspective exploded view of the bicycle pedal of the system of FIG. 1.

FIG. 3 is a perspective view of the cleat of the system of FIG. 1.

FIG. 4 is a perspective exploded view of the cleat of FIG. 3.

FIG. 5 is a view similar to FIG. 1, illustrating the cleat touching the surface of the pedal and beginning the engagement process.

FIG. 6 is a view similar to FIG. 1, illustrating the cleat in the process of forcing the pedal to spread open.

FIG. 7 is a view similar to FIG. 1, illustrating the cleat in full engagement with the pedal.

FIG. 8 is a perspective view of the environment of the invention, a conventional bicycle.

FIG. 9 is a perspective view of the environment of the invention, a conventional bicycle shoe.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

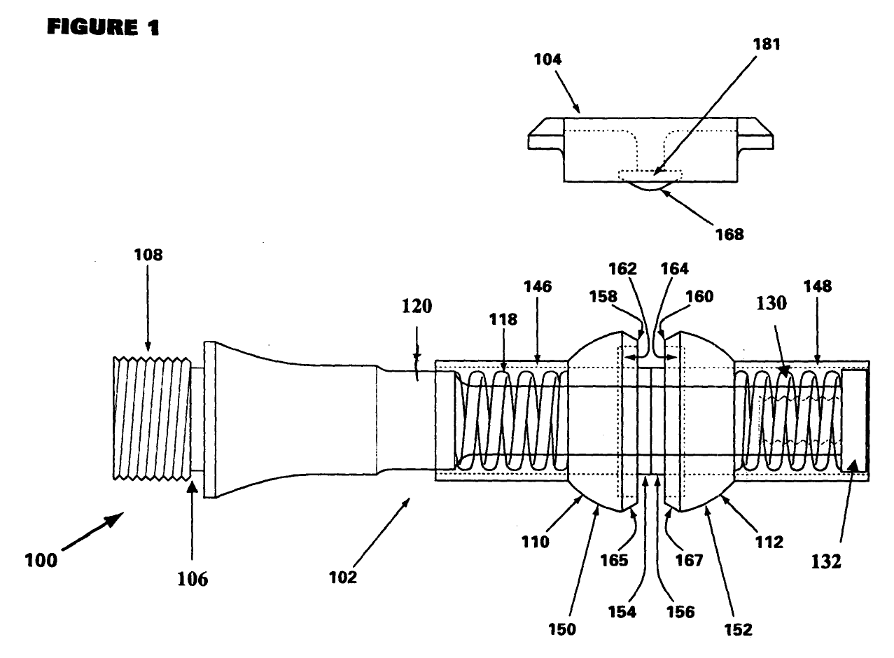

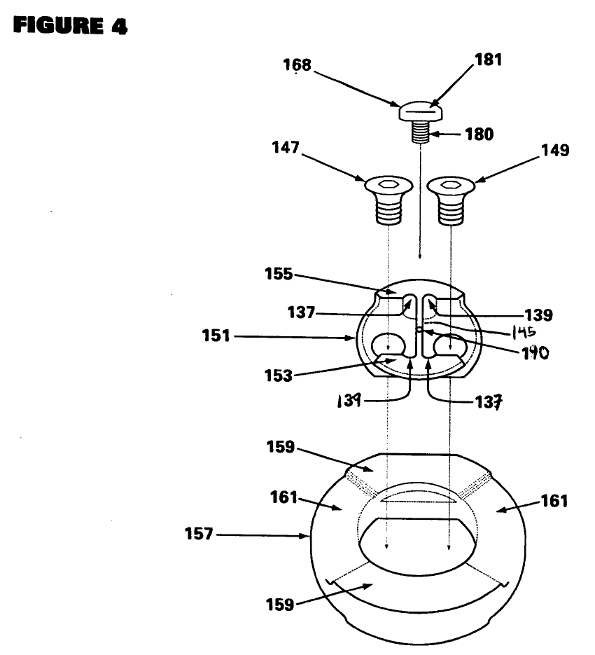

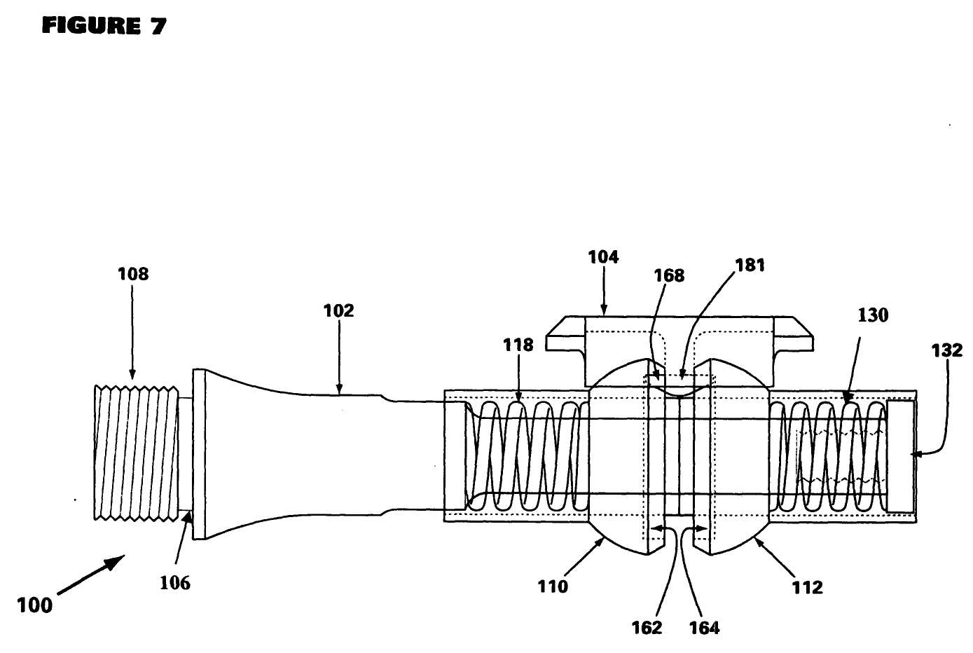

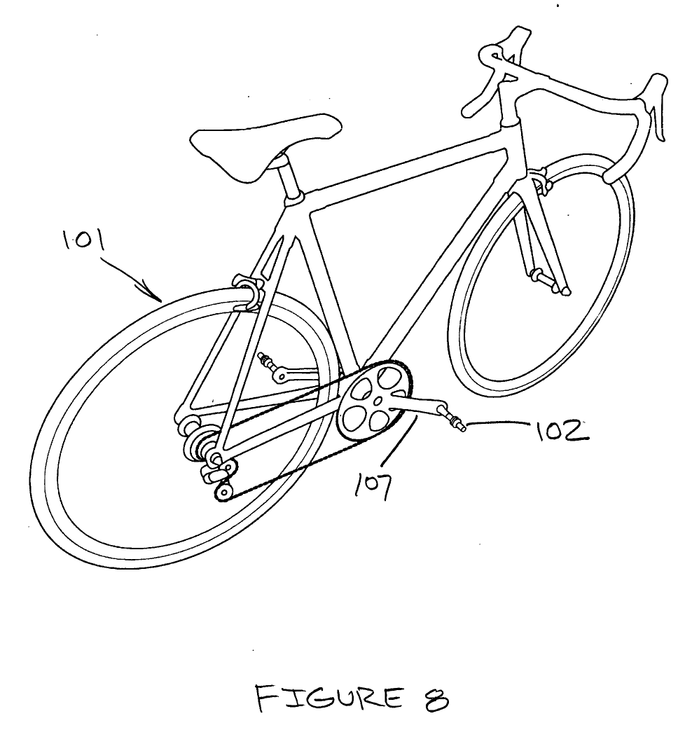

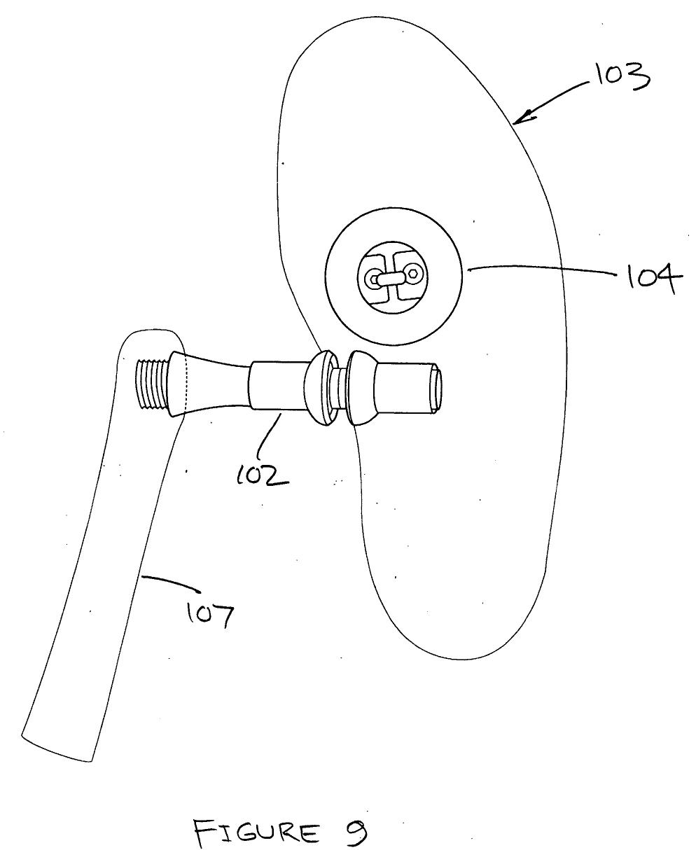

Shown in FIGS. 1-9 is a quick entry clipless bicycle pedal system 100 in accordance with a preferred embodiment, comprising a pedal 102 and cleat 104, for use with a conventional bicycle 101 and conventional bicycle shoe 103.

The pedal 102 includes a spindle 106 which attaches to the crank arm 107 of a conventional bicycle, the spindle 106 preferably having a threaded end 108 for attachment to the crank arm 107, as shown in the figures. The pedal 102 further includes first and second engagement components 110, 112, respectively, concentrically mounted on the spindle 106, for engagement of the cleat 104 mounted on a conventional bicycle shoe. The spindle 106 and engagement components 110, 112 are preferably made of a light metal such as titanium.

The engagement components 110, 112 are biased to a closing position wherein the components are forced against one another. The engagement components 110, 112 are further capable of side-to-side motion, with respect to the spindle central axis, allowing for a predetermined amount of axial float. Also, the system 100 allows the rider to move his/her foot in a lateral twist motion, as well as from side to side, providing for a wide range of float motion. Furthermore, the pedal is capable of rotating with respect to the attached shoe, which is necessary for normal pedaling of the bicycle.

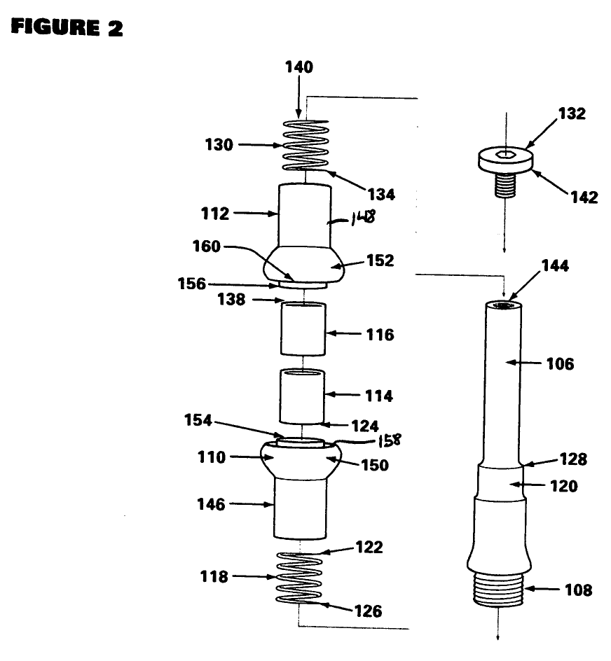

The engagement components 110, 112 are each mounted on the spindle 106. As shown in FIG. 2, a pair of cylindrical bearings 114, 116 are each preferably located between the spindle 106 and engagement components 110, 112, respectively, providing for a close fit, and allowing the engagement components 110, 112 to smoothly glide from side to side, and also rotate on the spindle 106. The bearings 114, 116, are preferably made of a smooth polymer or other smooth material that is capable of sliding on the spindle 106. This invention further contemplates the use of wheel components, or other means which would enable the engagement components 110, 112 to slide back and forth with respect to the spindle axis.

A first spring 118 is mounted on the spindle 106 and retained between the first engagement component 110, and a wide bottom portion 120 of the spindle 106. The top end 122 of the spring 118 preferably contacts the bottom end 124 of the bearing 114, and the bottom end 126 of the spring 118 contacts the base 128 of the portion 120. The spring 118, which is preferably covered by the engagement component 110 (together with the bearing 114) is shown in FIGS. 1 and 5-7 for illustrative purposes.

A second spring 130 is mounted on the spindle 106 and retained between the second engagement component 112 and end screw 132, the top portion 144 of the spindle 106 having inner threading for engaging the screw 132. The bottom end 134 of the spring 130 preferably contacts the bottom end 138 of the bearing 116, and the top end 140 of the spring 130 contacts the base 142 of the screw head. The spring 130 is preferably covered by the engagement component 112 (together with the bearing 116). It should be noted that although the engagement components 110, 112 are described as spring 118, 130 biased, this invention contemplates the use of other biasing elements, such as elastic bands or magnets, for example.

The engagement components 110, 112, which are preferably similar, comprise hollow cylindrical cores 146, 148, and flared out portions 150, 152, respectively. The outer edges 154, 156 of the cores 146, 148 extend beyond the outer edges 158, 160 of the flared out portions, 150, 152, respectively, such that when the outer edges 154, 156 of the cores 146, 148 touch, although there is a gap between the outer edges 158, 160 of the flared out portions, 150, 152. Additionally, the flared out portions 150, 152 are hollow, forming inner trenches 162, 164 (indicated by dotted lines in FIGS. 1 and 5-7), and preferably sloped on the outer regions 165, 167 adjacent the edges 158, 156, for smoothly guiding the cleat 104 as it slides down for engagement with the pedal 102, as will be described in more detail below.

The cleat 104 comprises a latch 181, which can be engaged within the engagement components 110, 112. According to a preferred embodiment, the latch 181 has a wide head 168 and lower shaft 180 coupled thereto, resembling a screw or “T” shape. The latch 181 may be mounted to a disk 151 of the cleat 104, preferably at a central location on the disk 151, and may be integrally formed with the disk 151 or attachable and detachable, for example via a screw/threaded engagement of the bottom of the shaft 180 with a hole 190 in the disk 151. In case where the latch 181 is attachable and detachable, a rider may have the option of choosing from a variety of different sized and/or shaped latches to suit individual preference.

The disk 151 preferably has opposite wall sections 153, 155, and may also have a central wall 145 having a central gapped space for the latch 181. Additionally, an outer ring 157, having opposite elevated regions 159, and opposite depressed regions 161, preferably surrounds the disk 151, such that the disk is embedded within the ring 157 with the elevated regions 159 directly adjacent the wall sections 153 and 155. Preferably, the inner disk 151 and latch 181 are manufactured from a metal, such as stainless steel, and the outer ring 157, is made of plastic, making the cleat 104 light and durable.

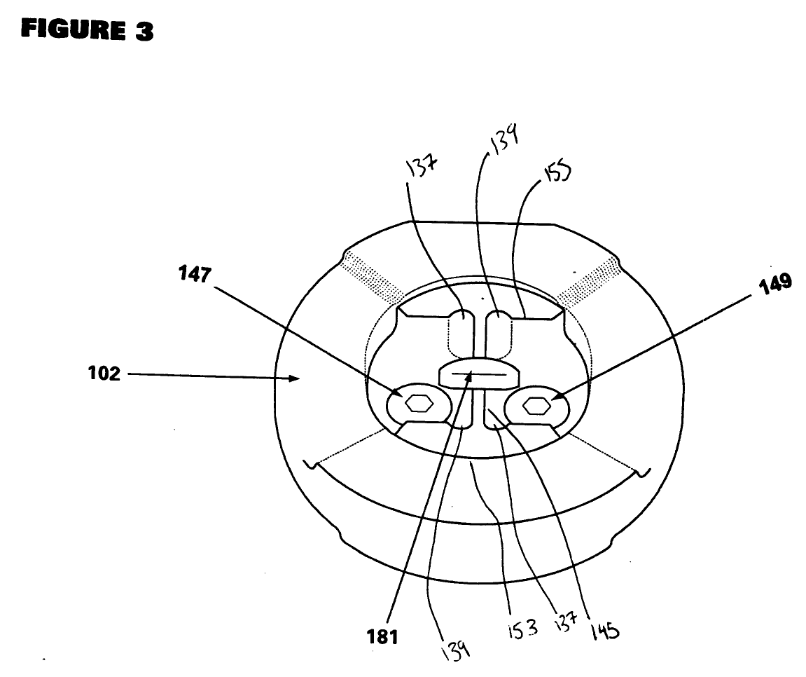

The cleat 104 may be installed onto a shoe having threaded holes by screwing each screw 147, 149, onto threaded holes in the sole of the shoe. (The specific cleat design shown in FIG. 3 is compatible with a shoe having two threaded holes, such as an SPD™ type shoe). Thus, the system 100 is easy to install, requiring minimal screw connections.

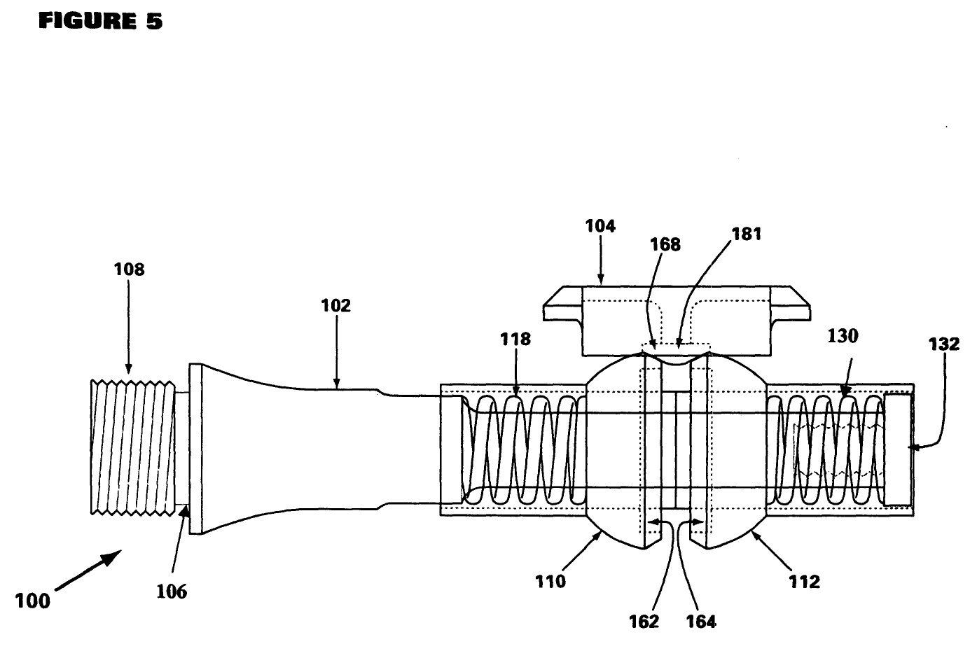

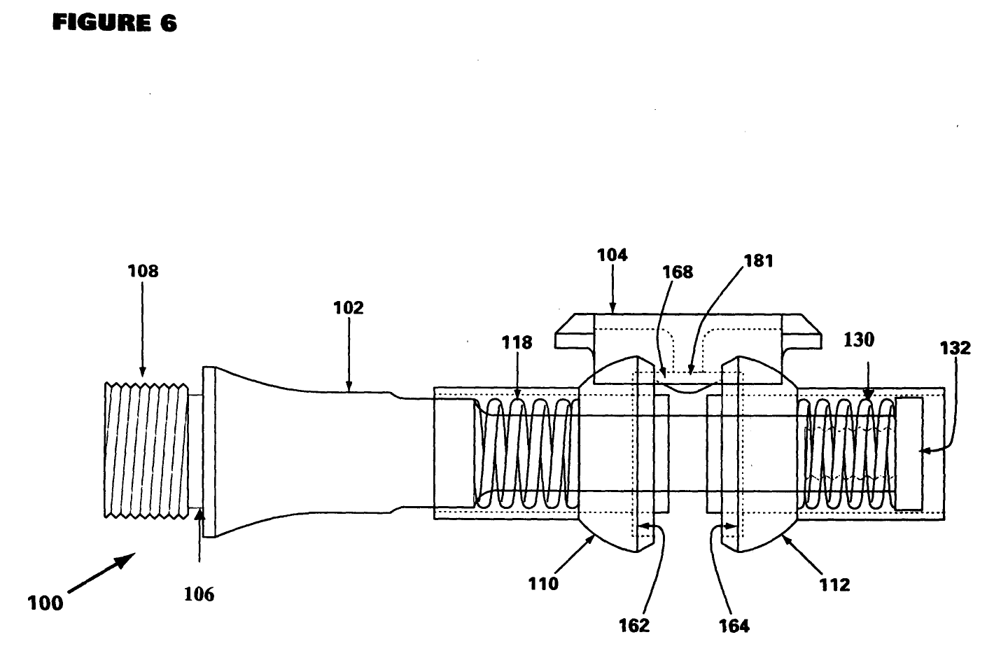

As illustrated in FIGS. 5-7, the engagement of the cleat 104 begins with the head 168 pressing against the flared out portions 150, 152, of the engagement components 110, 112, forcing the engagement components to axially spread apart, as shown in FIG. 6, from their original position, shown in FIG. 5, thereby compressing the springs 118, 130. (The latch 181 is shown in the figures in dotted lines for illustration purposes). The head 168 is pressed further down, and lodges within the inner trenches 162, 164, whereby the components 110, 112 are no longer forced apart, and are pushed back together to their original position (see FIG. 6) as the springs uncompress. This securely engages the cleat 104 within the engagement components 110, 112 of the pedal 102. The latch 181 is preferably sloped and/or curved, as shown in the figures, such that it smoothly glides along outer regions 165, 167 which are also preferably sloped and/or curved.

The preferred cylindrical configuration of the pedal 102 platform allows the cleat 104 to engage the pedal 102 at any position of the pedal 102 platform, by pressing the cleated shoe down on the pedal 102 platform. This is in contrast to single, double, or four sided platforms, of the prior art, which require the pedal 102 to be oriented in a specific manner for engagement. It should be understood, however, that the pedal 102 platform, including spindle 106 and engagement components, may also be made single-sided, double-sided, four-sided, and so on, without departing from the inventive concept.

Additionally, the preferred configuration of the cleat 104, which includes the depressed regions 161 of the outer ring 157, guide the rider to correctly position his/her shoe on the cleat 104, thus, providing for a true “no look” engagement system.

To disengage the cleat 104 from the pedal 102, the rider twists his/her foot, whereby transverse regions of the flared out portions 150, 152, are engaged between corresponding transverse corners 137 or 139 formed by the central wall 145 and opposite wall sections 153, 155. This places an axial force directing each of the engagement components 110, 112 to the open position, and compressing the springs 118, 130. Thus, the engagement is released, and the shoe/foot disengages from the pedal 102. It should be noted that the corners 137, 139 may be slightly grooved for receiving regions of the flared outer portions 150, 152, as shown in the figures.

While the flared out portions, 150, 152 of the engagement components 110, 112, are illustrated as semi-spherical, it should be readily understood that other configurations are possible, such as cylindrical, conical, square, etc. without departing from the inventive concept. The inner trenches 162, 164, should be at least deep enough to allow the head of the latch 181 to fit in engagement with the pedal 102, but may be deeper. Furthermore, it should be understood that the pedal 102 may be constructed with only one spring, coupled to either of the engagement components 110, 112 whereby movement of that component which is spring loaded would force the components to spread apart, during engagement.

1. A clipless bicycle pedal system comprising:
a spindle;
first and second engagement components mounted on said spindle adjacent one another, but forming a gap between at least portions of said engagement components; and
first and second biasing members directly coupled to said first and second engagement components, respectively,
wherein said biasing members axially force said engagement components towards one another tending to minimize the gap there between;
thereby providing a releasable engagement for a shoe-mounted cleat having a projecting latch member sized to be engaged by said gap.

2. The pedal system of claim 1 wherein said gap between said engagement components is continuous, thereby providing a uniformed, infinitely-sided pedal platform for engagement of said cleat projecting latch member around the spindle.

3. The pedal system of claim 1 wherein said biasing members are springs.

4. The pedal system of claim 1 wherein said engagement components are generally cylindrical.

5. The pedal system of claim 1 wherein said engagement components are capable of rotating on said spindle about its axis.

6. The pedal system of claim 1 wherein said engagement components are capable of side-to-side motion on said spindle, thereby providing the pedal with axial float.

7. The pedal system of claim 1, said engagement components are similar to one another, each comprising a hollow cylindrical core and a flared out portion concentric with and radially extending from said core,
wherein the gap is between the edges of the flared out portions.

8. The pedal system of claim 1, wherein said pedal system comprising:
engagement components have a hollow cylindrical core and a flared out portion concentric with and radially extending from said core, said flared out portions forming an engagement trench with said cylindrical core for engaging a cleat on a rider's shoe.

9. The pedal system of claim 1, further comprising:
a cleat having a projecting latch member sized to engage the gap between the pedal first and second engagement components, and the cleat is attachable to a conventional bicycle shoe.

10. The bicycle pedal system of claim 8, wherein said cleat further comprises a disk on which said latch is mounted; and
said disk is attachable to the forward portion of the sole of the shoe; and,
said disk is configured such that the user may rotate his or her foot while the cleat is engaged in the pedal.

11. A clipless bicycle pedal system comprising:
a pedal including a spindle;
at least one engagement component mounted on said spindle, said engagement component having a constant gap entirely around said spindle forming a uniformed infinitely sided platform; and
a cleat capable of engaging with said gap at any side of said platform.

12. The clipless bicycle pedal system of claim 11, comprising first and second engagement components mounted on said spindle, wherein said cleat is configured for engagement between said engagement components, said components being spring biased to a closing position wherein the components are forced against one another and said gap is minimized.

13. The clipless bicycle pedal system of claim 11, said engagement component capable of side-to-side motion with respect to the axis of said spindle, providing axial float when said cleat is engaged.

14. The clipless bicycle pedal system of claim 11, said engagement component and spindle being formed from titanium.

15. The clipless bicycle pedal system of claim 11, further comprising a cylindrical bearing mounted between said spindle and said engagement component, said cylindrical bearing having a smooth surface for allowing the engagement component to slide with respect to the axis of said spindle.

16. The clipless bicycle pedal system of claim 11, said cleat comprising a latch having a wide head that is generally rounded to guide the pedal into engagement position.

17. The clipless bicycle pedal system of claim 11, said cleat being coupled to a shoe worn on a rider's foot, and said engagement components and cleat being configured such that said rider is capable of twisting his/her foot while engaged in said pedal.

18. A method of engaging and disengaging a bicycle shoe to a bicycle pedal comprising:
providing a bicycle having a pedal mounted to a spindle with engagement components biased together to minimize the gap there between, the gap of constant width around the spindle;
providing a shoe-mounted cleat having a projecting member sized to engage the gap between the engagement components;
pressing the cleat projecting member against the gap between the pedal engagement components anywhere around the spindle, thereby moving of said pedal to an open position; and
further pressing said cleat against the pedal to latch said cleat projecting member thereby engagement component positions to a closed position, wherein substantially twisting said cleat projection member to axially force apart said pedal engagement components thereby widening said gap and allowing said bicycle shoe to disengage from said pedal.
